(19) United States
(12) Patent Application Publication
(10) Pub. No.: US 2003/0067228 A1
(43) Pub. Date: Apr. 10, 2003

(54) Heat dissipative brushless electric motor assembly

(76) Inventor: Chandu R. Vanjani, Van Nuys, CA (US)

Correspondence Address: Jack C. Munro, Agent of Record, Suite 225, 28720 Roadside Drive, Agoura Hills, CA, 91301, US

(21) Appl. No.: 09/972,628

(22) Filed: Oct. 9, 2001

(51) Int. Cl. H02K 9/00

(52) U.S. Cl. 310/64; 310/65

(57) ABSTRACT

A compact, self contained, heat dissipative, brushless motor assembly which has a stator fixedly mounted onto a hub. Located about the stator is a rotor with a shaft being connected to the rotor which is conducted through a center hole formed within the hub. A heat sink is attached to the hub. A controller is mounted on the heat sink with some of the heat generated by the controller to be dissipated by the heat sink. Rotation of the rotor causes rotation of a shaft which passes through the center through hole with this shaft to be optionally connectable to a planetary gear system. The planetary gear system is to be mounted within an alcove formed within the heat sink. The rotor includes a cover which includes a series of venting holes. The motor assembly is to be enclosed by a casing. Heat from the venting holes is to be conducted into the ambient through the casing.

### BACKGROUND OF THE INVENTION

1. Field of the Invention

The field of this invention relates to brushless electric motors and more particularly to a compact, small in size, powerful electric motor which has an internal controller which can A: be used to drive a vehicle, such as a bicycle or scooter, and where the motor is constructed to dissipate heat that is generated by the motor.

2. Description of the Related Art

Although the electric motor of the present invention has been found to have particular utility in conjunction with an electrically operated bicycle, the motor is also deemed to have utility in other environments, such as operating of a scooter and even in other environments that are unknown to the inventor at this particular time.

Electric motors have been used in the past to operate a bicycle electrically. The electric motors of the prior art have been rather large in size and are of relatively heavy weight. It is desirable to have the electric motor be as small as possible and also have the motor to be as light in weight as possible to thereby keep the overall weight of the bicycle as low as possible. Also, in the past, electric motors of bicycles have had exposed internal components. This is exceedingly undesirable as bicycles are frequently ridden through adverse weather conditions which will result in water and foreign material, such as mud, contaminating the internal components of the electric motor and making the electric motor non-operational. To protect the motor from water and foreign material, it is common to completely enclose the motor in a casing. All motors have a stator and a rotor. The stator will include a series of wire coils. The supplying of electricity to these wire coils will inherently produce heat. With the motor completely enclosed, the heat tends to be contained and not dissipated. As the heat increases, at some point the motor will become non-operational. The heat has to be dissipated.

Additionally, electric motors require the use of a controller which, in most instances, is an electronic controller which controls the different speeds that the motor is operated. Controllers also generate heat. In the past, it has been common to locate the controller a spaced distance from the motor so the heat generated by the controller will not possibly be able to damage the motor. However, from a manufacturing point-of-view, and also to lessen the number of different parts to be mounted on a bicycle or scooter, it is desirable to include the controller within the motor. Such a motor is shown within U.S. Pat. No. 6,104,112, entitled BRUSHLESS ELECTRIC MOTOR ASSEMBLY, by the present inventor. However, this motor has incurred the problem of overheating. Once the motor is overheated, it is necessary to shut down the motor for a period of time before reoperation can begin. The only way that the bicycle or scooter can be reoperated is to wait some time until the motor cools sufficiently before it can be restarted.

Additionally, it is normally desirable to use a planetary gear system in conjunction with such an electric motor that is used to operate a bicycle or scooter. The function of the planetary gear system is to gear down the output shaft of the motor to the driving wheel of the bicycle so as to keep the driving wheel operating within a desirable range of revolutions per minute. In the past, planetary gear systems were normally mounted separate from the motor of bicycles and scooters. Again, from a manufacturing point-of-view, it would be most desirable to incorporate the planetary gear system in conjunction with the motor in order to minimize the number of separate parts that are required when operating a bicycle or scooter by use of such a motor.

### SUMMARY OF THE INVENTION

A first basic embodiment of brushless electric motor assembly of this invention utilizes a hub which has a center through opening. An annular heat sink is attached to the hub with this heat sink being larger than the hub and having an annular ledge which is located diametrically outwardly from the hub. A controller is mounted on the annular ledge with some of the heat that is generated by the electronic components of the controller to be conducted through the heat sink. A stator is also mounted on the hub with the stator including wire coils which generate heat during operation of the motor assembly. A rotor is mounted about the stator with the motor being mounted on a shaft and the shaft rotationally mounted within the center through opening. Passing of electrical current through the wire coils of the rotor rotates the shaft. The rotor includes a cover which surrounds these wire coils. The cover includes a series of venting holes with these venting holes to provide an escape for generated heat from the wire coils and the controller which is then to be conducted through a casing into the ambient.

A further embodiment of this invention is where the first basic embodiment is modified by the casing having a series of exteriorly mounted heat conducting fins.

A further embodiment of this invention is where the first basic embodiment is modified by making the hub cylindrical.

A second basic embodiment of this invention comprises a heat dissipative brushless motor assembly which has an external, enclosing casing with this casing having an internal compartment. A disc shaped motor is rotatably mounted within the internal compartment with the rotor being mounted on a shaft. The disc shaped rotor also has an internal chamber. The disc shaped rotor has a series of venting holes to provide an escape for generated heat into the internal compartment and then into the internal chamber to then be conducted through the casing into the ambient.

A further embodiment of this invention is where the second embodiment includes a stator which has wire coils for conducting of electricity with the heat that is generated by the wire coils to also be dissipated through the casing into the ambient.

A further embodiment of this invention is where the second basic embodiment is modified by the casing having a series of exteriorly mounted heat conducting fins.

A further embodiment of this invention is where the second basic embodiment is modified by including of a heat sink located exteriorly of the internal chamber with the heat sink being mounted on a hub.

A still further embodiment of this invention is where the second basic embodiment includes a controller which has power devices constructed of electronic components which are mounted on the heat sink and located within the internal chamber of the motor with some of the heat that is generated within the controller to be conducted through this heat sink.

A third basic embodiment of heat dissipative brushless electric motor of the present invention which has a casing which has an internal compartment with a disc shaped rotor being rotatably mounted within the internal compartment. The rotor is mounted on a shaft. The disc shaped rotor also has an internal chamber. The rotor has a cover which surrounds a stator. This cover includes a series of venting holes with these venting holes to provide escape for generated heat from the stator which will then be conducted through the casing into the ambient.

A further embodiment of the present invention is where the third basic embodiment is modified by the stator being mounted within the internal chamber with this stator being mounted on a hub. The hub is also located within the internal chamber. The hub has a center through opening with a shaft being located within this center through opening.

A further embodiment of the present invention is where the third basic embodiment is modified by a heat sink being located exteriorly of the internal chamber with the heat sink being attached to the hub.

A still further embodiment of the present invention is where the third basic embodiment is modified by the heat sink including a disc shaped alcove with the center through opening being centrally located in this alcove. A planetary gear system is mounted within the disc shaped alcove. The shaft connects with the planetary gear system.

A still further embodiment of the present invention is where the third basic embodiment is modified with the exterior surface of the casing including a continuous series of exteriorly mounted heat conducting fins.

### BRIEF DESCRIPTION OF THE DRAWINGS

For a better understanding of the present invention, reference is to be made to the accompanying drawings. It is to be understood that the present invention is not limited to the precise arrangement shown in the drawings.

FIG. 1 is an external isometric view of the heat dissipative electric brushless motor assembly of the present invention;

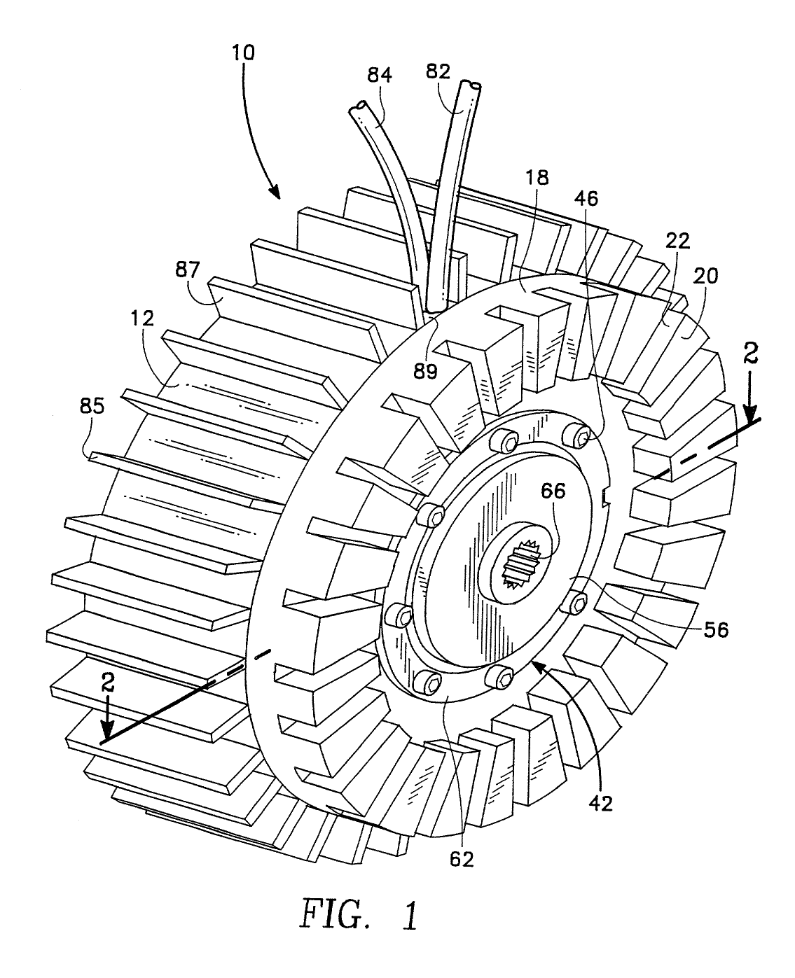

FIG. 2 is an exploded transverse cross-sectional view of the heat dissipative electric brushless motor assembly taken along line 2-2 of FIG. 1; and

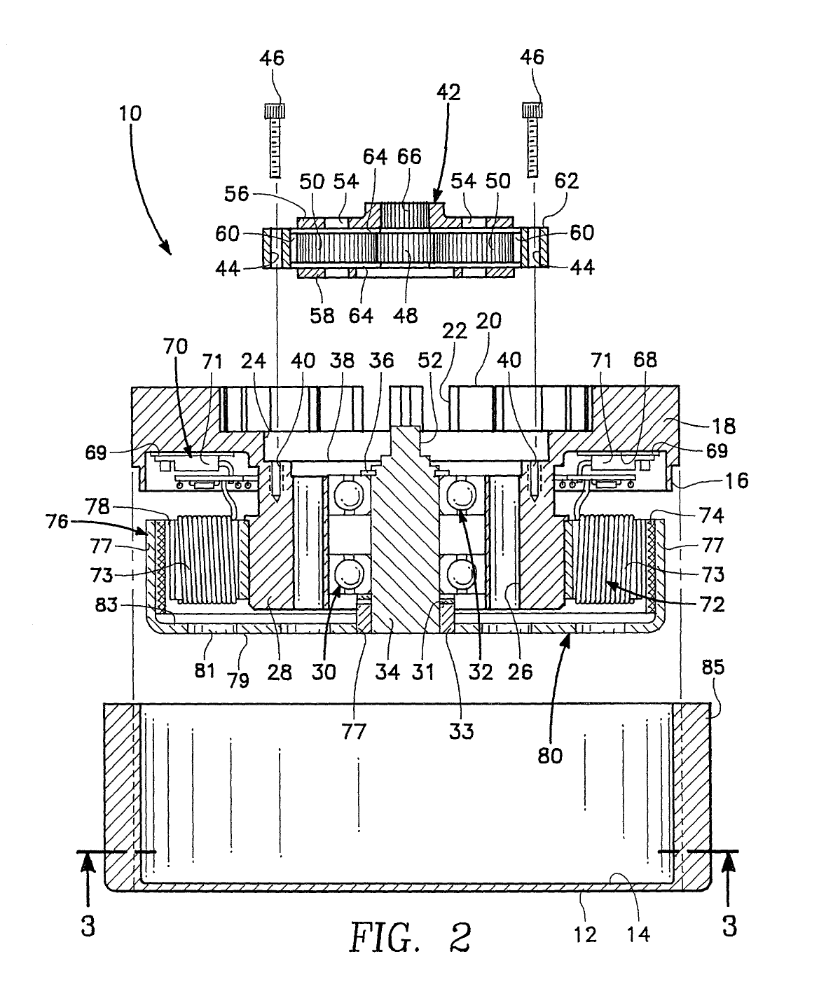

FIG. 3 is a transverse cross-sectional view through the casing in the exploded position as shown in FIG. 2 taken along line 3-3 of FIG. 2 to clearly depict the heat conducting fins mounted on the exterior surface of the casing and also clearly showing the pattern of venting holes formed within the cover of the rotor.

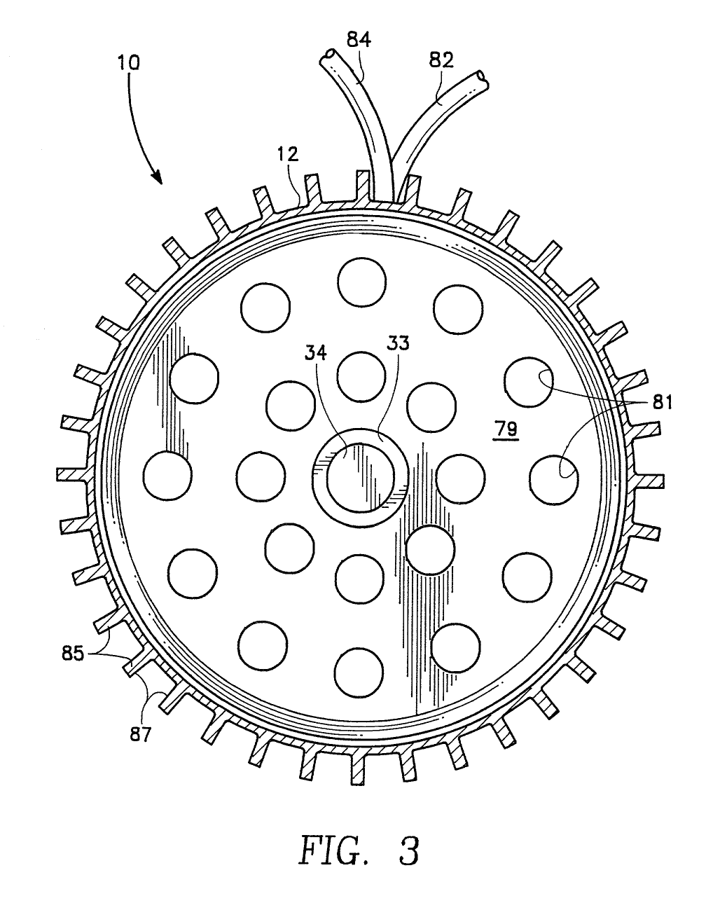

### DETAILED DESCRIPTION OF THE INVENTION

Referring particularly to the drawings, there is shown the electric motor assembly 10 of this invention which includes a cylindrically shaped casing 12 which has an internal compartment 14. The casing 12 is open at one end and is to be secured at annular groove 16 to a disc shaped heat sink 18. The heat sink 18 is constructed of a material such as aluminum that readily conducts heat. The heat sink 18 includes a mass of fins 20 with a radial groove 22 located between each directly adjacent pair of the fins 20. The function of the radial grooves 22 is to facilitate the conducting of heat from the fins 20 of the heat sink 18 into the ambient.

The heat sink 18 includes an alcove 24. The alcove 24 is basically cylindrically shaped and has a center through opening 26 connecting therewith. The center through opening 26 is formed through a hub 28 which is integral with the heat sink 18. Heat sink 18 is constructed of a material that readily conducts heat, such as aluminum. Mounted within the center through opening 26 are bearings 30 and 32. Low frictionally supported by the bearings 30 and 32 is a shaft 34. The shaft 34 is longitudinally fixed in position relative to bearing 32 by means of snap ring 36. The bearing 30 is preloaded by a disc leaf spring 31 which is held in place against bearing 30 by a bushing 33 which is mounted on shaft 34.

Mounted within the surface 38 of the hub 28 are a plurality of even spaced apart threaded holes 40. A planetary gear housing 42 is to be mounted within the alcove 24 in a close conforming manner. The planetary gear housing 42 includes a series of evenly spaced apart holes 44. Within each hole 44 there is to be located a threaded fastener 46 with each threaded fastener 46 to be threadably engaged with one of the threaded holes 40. This will securely mount the planetary gear housing 42 within the alcove 24. Within the planetary gear housing 42 there is mounted a sun gear 48 about which are mounted four in number of planet gears 50. The four planet gears 50 engage with the sun gear 48 within which there is located a spline connection, which is not shown. The spline connection of the sun gear 48 is to mechanically engage with the spline section 52 of the shaft 34.

Each of the planet gears 50 are rotatably mounted on separate stub shafts 54. The four in number of stub shafts 54 are fixedly mounted between an upper plate 56 and a lower plate 58. The planet gears 50 are in engagement with the ring gear 60 formed internally of a ring member 62. On each side of each planet gear 50 there is mounted a washer 64. The diameter of each washer 64 is slightly larger than the diameter of each planet gear 50. It is to be understood that the planet gears 50 are all of the same diameter. It is also to be noted that the sun gear 48 is of a substantially smaller diameter than the planet gears 50. The washers 64 function to keep the planet gears 50 longitudinally locked in position with the ring gear 60 by each washer 64 abutting against an edge of the ring gear 60. The upper plate 56 is locked to the lower plate 58 by means of the stub shafts 54.

The upper plate 56 includes a spline connection 66. The spline connection 66 is to connect to a driven shaft, which is not shown.

The driven shaft will then connect with the driving wheel of a bicycle and cause the bicycle to be motor operated.

The heat sink 18 has an internal annular ledge 68. Mounted on the annular ledge 68 is a printed circuit board 69 on which are mounted the electronic components 71 of an electronic controller 70. The function of the electronic controller 70 is that it will control the variable speed at which the bicycle will be operated. The controller 70 also will shut down the motor 10 if the motor 10 becomes overheated. The controller 70 will also shut off the motor 10 if the driving wheel of the bicycle becomes locked. The controller 70 will also shut off the motor 10 if the throttle cable, which controls the speed that the motor 10 is driven, becomes broken rather than having the motor 10 just being driven at maximum operating speed. Also, the controller 70 requires that the throttle has to be in zero speed position even before the motor will operate.

It is to be understood that the electric motor 10 of the present invention could be utilized to operate a scooter, rather than a bicycle with the only difference being that the motor for the scooter might be a little smaller in size. Within usage of a scooter, it may not be necessary to include a planetary gear system.

Mounted on the exterior surface of the hub 28 is a stator 72. The stator 72 includes a series of wire coils 73. Coils 73 will generate some heat during operation. The stator 72 is fixed to the hub 28. Mounted about the stator 72 is a magnet ring 74, having multiple magnet poles, which is mounted on the inner annular surface of a cup shaped cover 76. The cover 76 has an annular side wall 77 and a flat base 79. Flat base 79 has a series of venting holes 81 (twenty in number being shown which could be increased or decreased). Venting holes 79 could also be of a shape other than round. Venting holes 79 are to permit accumulated heat from controller 70 and coils 73 to be conducted from internal chamber 83 into internal compartment 14 where the heat is passed through aluminum casing 12 by conduction into the ambient. The discharge of the heat is facilitated by the use of the fins 85 which provide a large surface area by which air can pass over fins 85 and dissipate the heat into the ambient. The air passes through slots 87 with there being a single slot 87 between each directly adjacent pair of fins 85.It is to be understood that the magnet ring 74 is slightly spaced from the stator 72 forming an annular gap 78. The cover 76 is centrally secured to the shaft 34. The cover 76 and the magnet ring 74 form the rotor 80 of the motor 10 of this invention. The flat base 79 has a hole 77 within which is located the bushing 33.

The rotor 80 is to be positioned within the internal compartment 14 of the cover 12 and is to be permitted to freely rotate. Electrical operation of the stator 72 and the electronic components 71 of the controller 70 is accomplished by means of the electrical wires 82 and 84. Wires 82 and 84 pass through hole 85 in casing 12. The space surrounding wires 82 and 84 within hole 89 is sealed by epoxy resin (not shown). Electrical activation of the stator 72 will cause the rotor 80 to rotate which in turn will rotate the shaft 34. The spline section 52 will cause rotation of the sun gear 48 which will cause the planet gears 50 to rotate around the sun gear 48 and relative to ring gear 60 and will cause rotation of the upper plate 56 and lower plate 58. Therefore, the driven shaft (not shown) that is in engagement with the spline connection 66 will be rotated.

It can thus be seen that the electric motor of the present invention forms an overall disc shape which includes a controller 70 formed of electronic components 71 mounted there within and also is capable of including a planetary gear assembly mounted within the confines of the heat sink 18. Therefore, it is not necessary to utilize a separate controller and a separate planetary gear assembly.

What is claimed is:

1. A heat dissipative brushless electric motor assembly comprising:
a hub which has a center through opening;
an annular heat sink attached to said hub, said heat sink constructed of a heat conductive material, said heat sink being of a larger diameter than said hub, said heat sink having an annular ledge;
a controller including power devices of electronic components being mounted on said annular ledge, some of the heat that is generated by said controller to be conducted through said heat sink;
a stator being fixedly mounted on said hub, said stator including wire coils which generate heat during operation of said motor assembly; and
a rotor mounted about said stator, said rotor being secured to a shaft, said shaft being rotationally mounted within said center through opening, upon passing of an electrical current through said wire coils said rotor is rotated which rotates said shaft, said rotor including an cover which surrounds said wire coils, said cover including a series of venting holes, said venting holes to provide an escape for generated heat from said wire coils and said controller which will then be conducted through said outer cover into ambient.

2. The heat dissipative brushless electric motor assembly as defined in claim 1 wherein:
said casing having a series of exteriorly mounted heat conducting fins.

3. The heat dissipative brushless electric motor assembly as defined in claim 1 wherein:
said hub being cylindrical.

4. The heat dissipative brushless electric motor assembly as defined in claim 2 wherein:
said fins being continuous.

5. A brushless electric motor assembly comprising:
an external enclosing casing having an internal compartment; and
a disc shaped rotor rotatably mounted within said internal compartment, said rotor being mounted on a shaft, said disc shaped rotor having an internal chamber, said disc shaped rotor having a series of ventilating holes to provide an escape for generated heat from said internal chamber into said internal compartment to then be conducted through said external enclosing casing into ambient.

6. The heat dissipative brushless electric motor assembly as defined in claim 5 wherein:
a stator being mounted within said internal chamber, said stator having wire coils for conducting of electricity, heat generated from said wire coils is also to be conducted into said internal chamber and hence into said internal compartment to also then be conducted through said casing into the ambient.

7. The heat dissipative brushless electric motor assembly as defined in claim 5 wherein:
said casing having a series of exteriorly mounted heat conducting fins.

8. The heat dissipative brushless electric motor assembly as defined in claim 5 wherein:
a heat sink located exteriorly of said internal chamber, said heat sink being attached to a hub, said hub being mounted on said heat sink; and
a stator mounted within said internal chamber, said stator having wire coils for conducting of electricity, said stator being fixedly mounted on said hub, said hub being located within said internal chamber, said hub having a center through hole, said shaft being located within said center through hole, whereby heat that is generated from said wire coils is conducted into said internal chamber and then into said internal compartment to be dissipated into the ambient through said casing.

9. The heat dissipative brushless electric motor assembly as defined in claim 5 wherein:
a controller including power devices, electronic components being mounted on said heat sink and located within said internal chamber, heat that is generated by said controller is to be conducted through said heat sink and also into said internal chamber to then be dissipated through said casing.

10. A heat dissipative brushless electric motor assembly comprising:
a casing having an internal compartment; and
a disc shaped rotor rotatably mounted within said internal compartment, said rotor being mounted on a shaft, said disc shaped rotor having an internal chamber, said rotor having a cover which surrounds a stator, said casing includes a series of venting holes, said venting holes to provide an escape for generated heat from said stator which will then be conducted through said casing into ambient.

11. The heat dissipative brushless electric motor assembly as defined in claim 10 wherein:
said stator being mounted within said internal chamber, said stator being fixedly mounted on a hub, said hub being located within said internal chamber, said hub having a center through opening, said shaft being located within said center through opening.

12. The heat dissipative brushless electric motor assembly as defined in claim 11 wherein:
a heat sink located exteriorly of said internal chamber, said heat sink being attached to said hub, said hub being mounted on said heat sink, whereby upon passing of electric current through said stator said rotor is rotated which rotates said shaft.

13. The heat dissipative brushless electric motor assembly as defined in claim 12 wherein:
said heat sink includes a disc shaped alcove, said center through opening being centrally located within said disc shaped alcove, a planetary gear system being mounted within said disc shaped alcove, said shaft connecting with said planetary gear system.

14. The heat dissipative brushless electric motor assembly as defined in claim 10 wherein:
said casing having a series of exteriorly mounted heat conducting fins.

15. The heat dissipative brushless electric motor assembly as defined in claim 14 wherein:
said fins being continuously arranged on said casing.
